(19) United States
(12) Patent Application Publication
(10) Pub. No.: US 2025/0199298 A1
(43) Pub. Date: Jun. 19, 2025

(54) MITIGATION OF ATMOSPHERIC EFFECTS ON LASER BEAM PROPAGATION ASSISTED BY LASER-INDUCED PLASMA

(71) Applicant: Technology Innovation Institute - Sole Proprietorship LLC, Masdar City (AE)

(72) Inventor: Guillaume Matras, Abu Dhabi (AE)

(73) Assignee: Technology Innovation Institute - Sole Proprietorship LLC, Masdar City (AE)

(21) Appl. No.: 18/897,899

(22) Filed: Sep. 26, 2024

(30) Foreign Application Priority Data
Dec. 14, 2023 (AE) P6003262/2023

(51) Int. Cl. G02B 27/00; G01J 1/02

(52) U.S. Cl. CPC G02B 27/0068; G01J 1/0238

(57) ABSTRACT

A target-free laser correction system including a primary laser emitter configured to emit a primary laser beam on a target in a target zone, a secondary laser emitter configured to emit a secondary laser beam on a region of air in the target zone, optics optically coupled to the primary laser emitter and the secondary laser emitter. The optics may be configured to optically focus the secondary laser beam on the region of air in the target zone, correct a distortion of a wavefront of the secondary laser beam caused by atmospheric effects on the secondary laser beam, and focus the primary laser beam on the target in the target zone. Also included is a sensor configured to detect energy emitted from laser induced plasma created by the secondary laser beam, and a controller configured to control operation of the primary laser emitter, secondary laser emitter, optics and sensor.

### CROSS-REFERENCE TO RELATED APPLICATIONS

This application claims priority to United Arab Emirates Patent Application No. P6003262/2023, filed Dec. 14, 2023, the entire contents of which is incorporated by reference herein.

### FIELD

A system and method for mitigation of atmospheric effects on laser beam propagation assisted by laser-induced plasma.

### BACKGROUND

The propagation of a high-power laser beam in the atmosphere may encounter atmospheric turbulences caused by wind and temperature fluctuations, which lead to rapid fluctuations in the intensity and direction of the laser beam, known as scintillation. Moreover, the laser beam may heat up the air along its path, thereby creating a region of low refractive index known as thermal blooming. These undesired effects may cause the beam to diverge with distorted intensity distribution and lose focus from its intended target focal region, thereby reducing its power density and effectiveness. Even if the weather conditions are well known, it is difficult to predict local and instantaneous variations in the atmosphere. This is problematic given that sensors for measuring beam distortions are typically not located near the target focal region.

### SUMMARY

In one aspect, the present disclosure relates to a target-free laser correction system including a primary laser emitter configured to emit a primary laser beam on a target in a target zone, a secondary laser emitter configured to emit a secondary laser beam on a region of air in the target zone, optics optically coupled to the primary laser emitter and the secondary laser emitter. The optics may be configured to optically focus the secondary laser beam on the region of air in the target zone, correct a distortion of a wavefront of the secondary laser beam caused by atmospheric effects on the secondary laser beam, and focus the primary laser beam on the target in the target zone. Also included is a sensor configured to detect energy emitted from laser induced plasma created by the secondary laser beam, and a controller configured to control operation of the primary laser emitter, secondary laser emitter, optics and sensor.

In embodiments of this aspect, the disclosed system according to any one of the above example embodiments, wherein the sensor is configured to detect the energy emitted from the laser induced plasma external to a path of the secondary laser beam.

In embodiments of this aspect, the disclosed system according to any one of the above example embodiments, wherein the sensor is configured to detect the energy emitted from the laser induced plasma along a path of the secondary laser beam.

In embodiments of this aspect, the disclosed system according to any one of the above example embodiments, wherein the optics include an adaptive optics for correcting the distortion of the wavefront.

In embodiments of this aspect, the disclosed system according to any one of the above example embodiments, wherein the controller may be configured to correct the distortion of the wavefront in the target zone by controlling the optics to pre-distort the wavefront of the emitted secondary laser beam such that pre-distorted wavefront counteracts the distortion caused by the atmospheric effects.

In embodiments of this aspect, the disclosed system according to any one of the above example embodiments, wherein the controller may be configured to correct the distortion of the wavefront such that the corrected wavefront in the target zone has a power intensity distribution set by the controller.

In embodiments of this aspect, the disclosed system according to any one of the above example embodiments, wherein the controller may be configured to determine the region of air in the target zone as being a set distance from the target in the target zone.

In embodiments of this aspect, the disclosed system according to any one of the above example embodiments, wherein the controller may be configured to a) control the secondary laser emitter to emit the secondary laser beam through the optics to focus the secondary laser beam on the region of air in the target zone, b) control the sensor to detect the energy emitted from the laser induced plasma created by the secondary laser beam irradiating the region of air in the target zone, c) estimate, based on the detected energy emitted from the laser induced plasma, a quality of the wavefront of the secondary laser beam in the target zone, d) control the optics to correct the distortion of the wavefront, and e) control the primary laser emitter to emit the primary laser beam through the optics to focus the primary laser beam on the target in the target zone.

In embodiments of this aspect, the disclosed system according to any one of the above example embodiments, wherein the controller may be configured to analyze the energy emitted from the laser induced plasma after the correction to confirm that the distortion of the wavefront is corrected.

In embodiments of this aspect, the disclosed system according to any one of the above example embodiments, wherein the controller may be configured to control the optics to adjust the focus of the secondary laser beam and the primary laser beam between the region of air in the target zone and the target in the target zone respectively.

In one aspect, the present disclosure relates to a target-free laser correction method including a) controlling, by a controller a secondary laser emitter to emit a secondary laser beam through optics to focus the secondary laser beam on a region of air in a target zone, b) controlling, by the controller, a sensor to detect energy emitted from laser induced plasma created by the secondary laser beam irradiating the region of air in the target zone, c) estimating, by the controller, based on the detected energy emitted from laser induced plasma, a quality of a wavefront of the secondary laser beam in the target zone, the distortion caused by atmospheric effects on the secondary laser beam, d) controlling, by the controller, the optics to correct the distortion of the wavefront, and e) controlling, by the controller, a primary laser emitter to emit the primary laser beam through the optics to focus the primary laser beam on a target in the target zone.

In embodiments of this aspect, the disclosed method according to any one of the above example embodiments includes detecting, by the sensor, the energy emitted from the laser induced plasma external to a path of the secondary laser beam.

In embodiments of this aspect, the disclosed method according to any one of the above example embodiments includes detecting, by the sensor, the energy emitted from the laser induced plasma along a path of the secondary laser beam.

In embodiments of this aspect, the disclosed method according to any one of the above example embodiments includes correcting, by an adaptive optics of the optics, the distortion of the wavefront.

In embodiments of this aspect, the disclosed method according to any one of the above example embodiments includes correcting, by the controller, the distortion of the wavefront in the target zone by controlling the optics to pre-distort the wavefront of the emitted secondary laser beam such that pre-distorted wavefront counteracts the distortion caused by the atmospheric effects.

In embodiments of this aspect, the disclosed method according to any one of the above example embodiments includes correcting, by the controller, the distortion of the wavefront such that the corrected wavefront in the target zone has a power intensity distribution set by the controller.

In embodiments of this aspect, the disclosed method according to any one of the above example embodiments includes determining, by the controller, the region of air in the target zone as being a set distance from the target in the target zone.

In embodiments of this aspect, the disclosed method according to any one of the above example embodiments includes periodically repeating, by the controller, steps (a)-(e) to compensate for the atmospheric effects that vary over time.

In embodiments of this aspect, the disclosed method according to any one of the above example embodiments includes analyzing, by the controller, the energy emitted from the laser induced plasma after the correction to confirm that the distortion of the wavefront is corrected.

In embodiments of this aspect, the disclosed method according to any one of the above example embodiments includes controlling, by the controller, the optics to adjust the focus of the secondary laser beam and the primary laser beam between the region of air in the target zone and the target in the target zone respectively.

### BRIEF DESCRIPTION OF THE DRAWINGS

So that the way the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 shows a block diagram of a target-free laser correction system, according to an example embodiment of the present disclosure.

FIG. 2 shows a flowchart of the operation of the laser system in FIG. 1, according to an example embodiment of the present disclosure.

FIG. 3A shows a block diagram of a target-free laser correction system with off-axis plasma detection, according to an example embodiment of the present disclosure.

FIG. 3B shows a flowchart of the operation of the target-free laser correction system with off-axis plasma detection in FIG. 3A, according to an example embodiment of the present disclosure.

FIG. 4A shows a block diagram of a target-free laser correction system with on-axis plasma detection, according to an example embodiment of the present disclosure.

FIG. 4B shows a flowchart of the operation of the target-free laser correction system with on-axis plasma detection in FIG. 4A, according to an example embodiment of the present disclosure.

FIG. 5A shows a block diagram of a target-free laser correction system for a target tracking application, according to an example embodiment of the present disclosure.

FIG. 5B shows a flowchart of the operation of the target-free laser correction system for a target tracking application in FIG. 5A, according to an example embodiment of the present disclosure.

FIG. 6 shows a block diagram of a controller for the target-free laser correction system, according to an example embodiment of the present disclosure.

### DETAILED DESCRIPTION

Various example embodiments of the present disclosure will now be described in detail with reference to the drawings. It should be noted that the relative arrangement of the components and steps, the numerical expressions, and the numerical values set forth in these example embodiments do not limit the scope of the present disclosure unless it is specifically stated otherwise. The following description of at least one example embodiment is merely illustrative in nature and is in no way intended to limit the disclosure, its application, or its uses. Techniques, methods, and apparatus as known by one of ordinary skill in the relevant art may not be discussed in detail but are intended to be part of the specification where appropriate. In all the examples illustrated and discussed herein, any specific values should be interpreted to be illustrative and non-limiting. Thus, other example embodiments may have different values. Notice that similar reference numerals and letters refer to similar items in the following figures, and thus once an item is defined in one figure, it is possible that it need not be further discussed for the following figures. Below, the example embodiments will be described with reference to the accompanying figures.

In various applications (e.g., laser countermeasure applications, laser power beaming applications, etc.), a laser beam may be emitted into the atmosphere over long distances by a telescope towards a target. In a laser countermeasure application example, the laser beam may be focused on a sensor of a target vehicle or structure with the goal of jamming operation of the sensor. In a laser power beaming application example, the laser beam may be focused on a wireless power receiver of a target vehicle or structure to wirelessly charge the target with the laser power. In either case, the telescope generally increases the diameter of the laser beam at the exit aperture of the optics. As the laser beam exits the telescope aperture, the diameter of the laser beam gradually narrows with increased distance from telescope aperture such that the laser beam attains a desired diameter at a focal region at the location of the target. In other words, the laser beam narrows along the optical path until it reaches the desired focal region for performing the laser application. However, along the optical path, the laser beam wavefront is distorted due to atmospheric turbulences. As a result, the laser beam diameter is enlarged and the wavefront is distorted near the desired focal region such that the laser beam is less effective at performing the laser application (i.e., laser power is diminished upon reaching the target).

The disclosed methods, devices and systems herein overcome the limitations of the existing systems by providing target-free method mitigation of atmospheric effects on laser beam propagation by way of laser-induced plasma. Specifically, the disclosed methods, devices and systems herein irradiate a physical target located in the desired focal region with a first laser (herein referred to as a primary laser) to achieve a desired application (e.g., laser countermeasure, laser power beaming, etc.) and utilize a second laser (herein referred to as a secondary laser) to irradiate air in the vicinity of the target in the desired focal region to generate target-free laser-induced plasma. This laser-induced plasma generates energy in the form of both on-axis and off-axis electromagnetic (EM) radiation, spanning a spectrum over a range (e.g., MHz to THz such as from microwave to ultraviolet wavelengths). This radiation may be detected and analyzed by the laser system to determine a quality of the laser wavefront. The quality may be dictated by wavefront distortions of the secondary laser beam at the focal region, and may be quantified by an intensity (e.g., amplitude) of the back emitted signal. The estimated wavefront quality may therefore be used to control adaptive optics such as a deformable mirror to pre-distort the secondary laser beam wavefront upon emission to counteract the distortions encountered during propagation resulting in a secondary laser beam wavefront that is corrected at the focal region (e.g., the laser is properly focused on the focal region). In other words, the system attempts to increase (e.g., maximize) the intensity of the back emitted signals, because increasing intensity of the back emitted signals indicates corresponding increase in quality of the laser wavefront at the target (i.e., as the wavefront approaches an optimal wavefront, the intensity of the back emitted signals increase). Since the primary laser beam is also emitted along the same optical path, and experiences the same distortions, the wavefront of the primary laser beam is also corrected by the adaptive optics such that the primary laser beam is properly focused on the physical target.

The adaptive optics may be controlled in various manners. In one example, the emission of the secondary laser to generate the laser-induced plasma may be continuously performed such that the adaptive optics is continuously controlled to continuously update the compensation for distortions caused by propagation effects. In another example, the emission of the secondary laser to generate the laser-induced plasma may be periodically performed such that the adaptive optics is controlled to periodically update the compensation for distortions caused by propagation effects.

The primary laser and secondary laser may be transmitted along the same path or different paths and may have the same or different focal region. In one example, the primary laser may be focused on the physical target, while the secondary laser may also be focused on the physical target thereby achieving target-based mitigation of propagation effects. In another example, the primary laser may be focused on the physical target, while the secondary laser may be focused on a region in the air short of the physical target thereby achieving target-free mitigation of propagation effects. In yet another example, laser may be emitted along a first optical path and focused on the physical target, while the secondary laser may be emitted along a second optical path focused on a point in the air in vicinity of the physical target thereby achieving target-free mitigation of propagation effects. In either configuration, the primary laser and secondary laser may be emitted simultaneously or sequentially. In other words, when used simultaneously (as described with respect to the figures below), the secondary laser may be used to create plasma and control the adaptive optics as described above, while the primary laser is lasing the target. In contrast, when used sequentially, the secondary laser may be used to create plasma and control the adaptive optics as described above, and then turned off at which point the primary laser is then turned on to perform lasing of the target.

The laser system and method described herein may be used in various free-space laser-based applications including but not limited to laser countermeasure applications and laser power beaming applications to name a few. For example, the laser system may be fitted with integrated steerable optics (e.g., steerable mirrors, etc.) to steer the laser beams on a physical target that may be a static or moving target. The steerable optics may steer the laser beams to perform laser countermeasure applications such as jamming and confusing laser-based guidance systems, or to perform laser power beaming applications such as charging drones, satellites and other devices located remote from the laser system.

Benefits of the disclosed methods, devices and systems include but are not limited to achieving a target-free method for determining and compensating for atmospheric disturbances to improve energy transfer conservation along an optical path. This is achieved by generating laser-induced plasma in a region near a physical target, estimating quality of the laser beam wavefront at the region and compensating for distortions to properly focus the laser on the physical target. Various embodiments of the system and method are described below with respect to the figures. It is noted that off-axis and on-axis solutions may estimate quality of the wavefront based on the detected intensity of the back emitted signals (e.g., RF signals, Optical signals, etc.) which correlate to the wavefront quality at the target zone. In other words, the wavefront does not need to be detected/determined, but rather may be estimated from the intensity of the back emitted signals. In another example of the on-axis solution, the system may detect/determine the exact wavefront by using a wavefront sensor. Furthermore, emission spectra include atomic emission lines and molecular emission bands, along with other emissions, all of which are influenced by the nature of the plasma source. Plasma temperature therefore increases as laser intensity increases at the focal point. The solution is generally based on laser intensity being proportional to a Strehl ratio parameter which compares actual performance with ideal performance. For example, the Strehl ratio of focusing optics including spherical and aspheric lenses is the ratio of maximum focal spot irradiance of the actual optic from a point source to the ideal maximum irradiance from a theoretical diffraction-limited optic. A Strehl ratio of 1, for example, would indicate that an optic is perfect and aberration free. In other words, as the wavefront becomes more ideal, the laser intensity at the target increases resulting in the intensity of the back emitted signal increasing. The ideal intensity of the back emitted laser is known and compared to the actual intensity of the back emitted laser to determine quality of the wavefront.

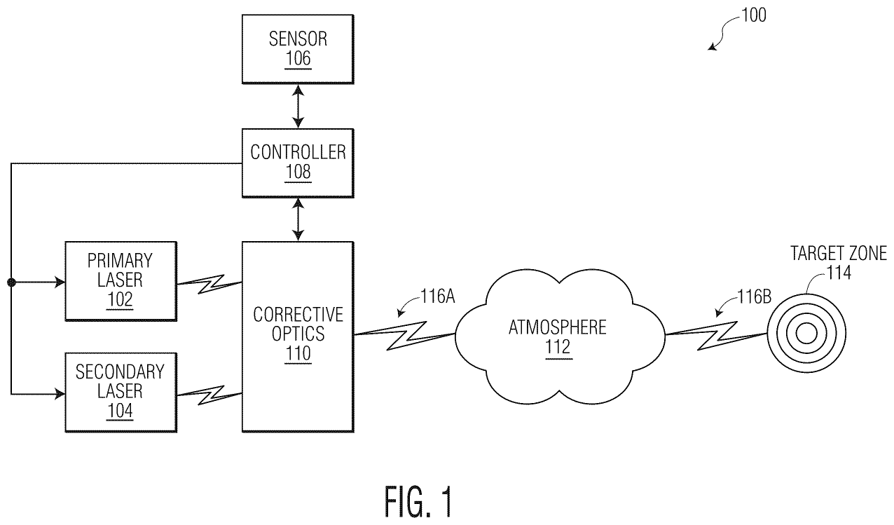

FIG. 1 shows a block diagram 100 of a target-free laser correction system. The system generally includes primary laser emitter 102, secondary laser emitter 104, sensor 106, controller 108 and corrective optics 110. During operation, both primary laser emitter 102 and secondary laser emitter 104 emit primary and secondary laser beams 116A through atmosphere 112 towards target zone 114. Atmosphere 112 generally includes disturbances that produce distortions in the laser beams 116B irradiating the target. In one example, the primary laser beam (e.g., continuous wave laser or other type of laser) is focused on a physical target (not shown) within target zone 114, while the secondary laser beam is focused on a section of air within target zone 114. Generally, the secondary laser beam is a high-power laser beam (e.g., GW or TW peak power pulsed laser beam) that generates laser-induced plasma in a section of air within target zone 114. This laser induced plasma emits feedback to sensor 106 in the form of off-axis (i.e., external to the optical path) electromagnetic radiation (e.g., ultraviolet light, visible spectrum light, microwaves, etc.) or on-axis (i.e., along the optical path) back emitted optical signals (e.g., optical signals that travel back along the laser beam optical path). In some examples, sensor 106 may be an intensity sensor (e.g., photodiode, EM detector, etc.) configured to detect intensity of the back emitted signals. Controller 108 analyzes the feedback (e.g., on-axis and/or off-axis signal intensity) sensed by the sensor, estimates quality of a wavefront of the secondary laser beam and adjusts corrective optics 110 maximize the plasma intensity detected by the sensor resulting from a proper focusing of the secondary laser beam. Adjustment of the secondary laser beam results in similar corrections to the primary laser beam since they both travel along the same optical path through atmosphere 112. An overall goal of the system is to modify the wavefronts of emitted laser beams 116A to compensate for distortions introduced by atmosphere 112 such that the wavefronts of the target received laser beams 116B are corrected. Although sensor 106 may be an off-axis or on-axis intensity sensor in one example, it is noted that sensor 106 in another example may be a wavefront sensor that directly measures the wavefront from on-axis optical signals.

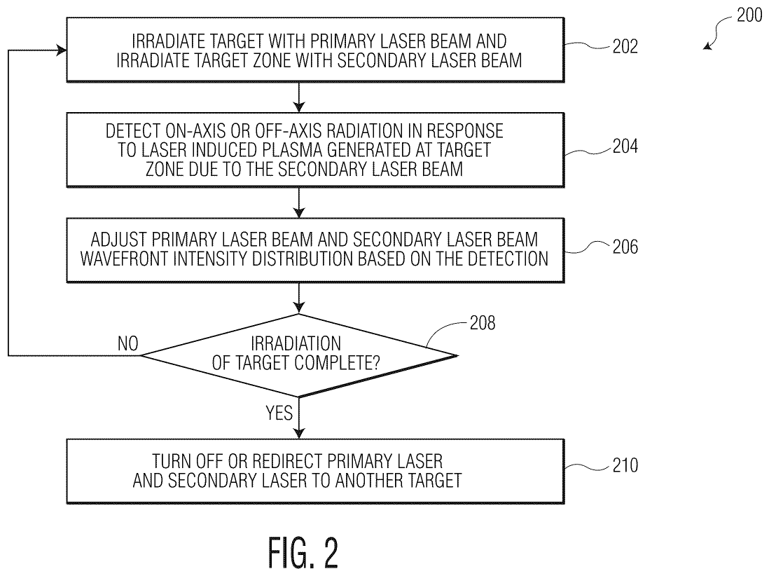

FIG. 2 shows a flowchart 200 of the operation of the laser system in FIG. 1. In step 202, controller 108 controls primary laser emitter 102 to irradiate the physical target in target zone 114 with a primary laser beam to perform a laser-based application. Controller 108 also controls secondary laser emitter 104 to irradiate air in target zone 114 with a secondary laser beam to generate laser-induced plasma. In step 204, sensor 106 detects either off-axis radiation emitted from the laser-induced plasma or on-axis back emitted optical signals caused by the laser-induced plasma. The off-axis radiation may be directly sensed by sensor 106. The back emitted optical signals may be received and routed by corrective optics 110 to sensor 106. In step 206, controller 108 controls corrective optics 110 (e.g., adaptive optics such as a deformable mirror) to adjust the wavefront of the secondary laser beam which also results in an adjustment of the primary laser beam since they utilize the same corrective optics. In one example, the adjustment is a pre-distortion introduced into the laser beam wavefront that counteracts the distortion of the wavefront due to disturbances in atmosphere 112. The result is that the primary laser beam is properly focused on the physical target. In step 208, controller 108 determines if irradiation of the physical target is complete. If irradiation of the physical target is not complete, then controller 108 continues to control corrective optics 110 to adjust the wavefront of the secondary laser beam in step 206 such that the physical target may be properly irradiated by the primary laser beam. It is noted that step 206 may be performed continuously or periodically. If, however, in step 208 the irradiation of the physical target is complete, then in step 210 controller 108 turns OFF or redirects the primary laser and secondary laser to another target. It is noted that the corrective optics (e.g. adaptive optics) are controlled by controller 108 according to an optics correction algorithm which is based on a known relationship between the intensity of the detected back emitted signals and the quality of the laser wavefront at the target. This relationship may be determined through various methods including reinforcement learning where a reinforcement learning model is trained using data sets where parameters such as wavelength range of the plasma, plasma intensity, laser wavefront at the target, and deformable mirror status are correlated to define a reward function to apply correction on the adaptive optics. Once the reinforced learning control is trained, intensity may be used to control the adaptive optics without the need of a wavefront sensor. By measuring plasma intensity, the adaptive optics (e.g., deformable mirror) may be controlled to accurately reduce distortions of the wavefront at the target by increasing (e.g., maximizing) the intensity of the back emitted signals. In another method, a control technique (without the use of machine learning) may implement a classical feedback control loop by measuring plasma intensity and attempting to adjust the adaptive optics to maximize plasma intensity in a similar manner. In other words, the system controls the adaptive optics with the goal of increasing (e.g., maximizing) intensity of the back emitted signals which correlates to a correction of the laser wavefront at the target zone.

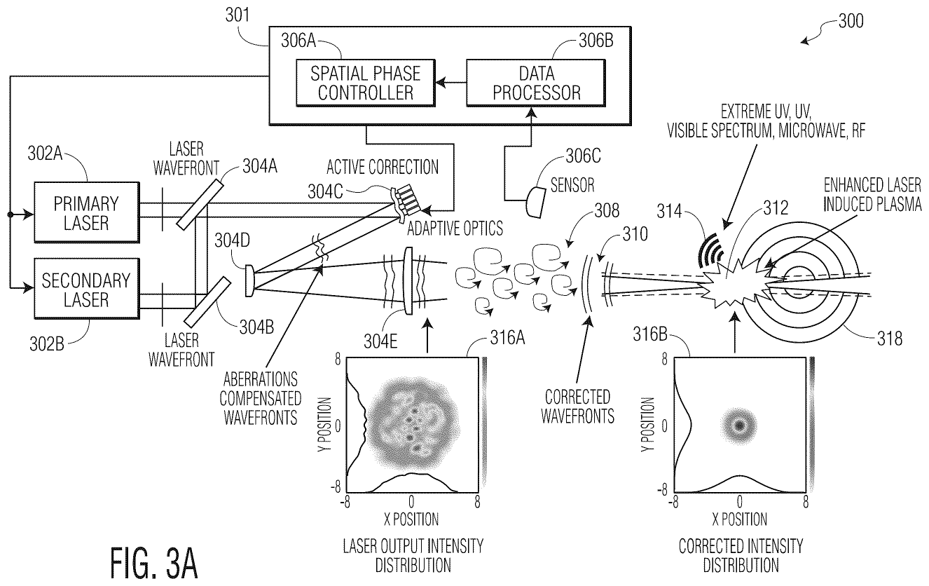

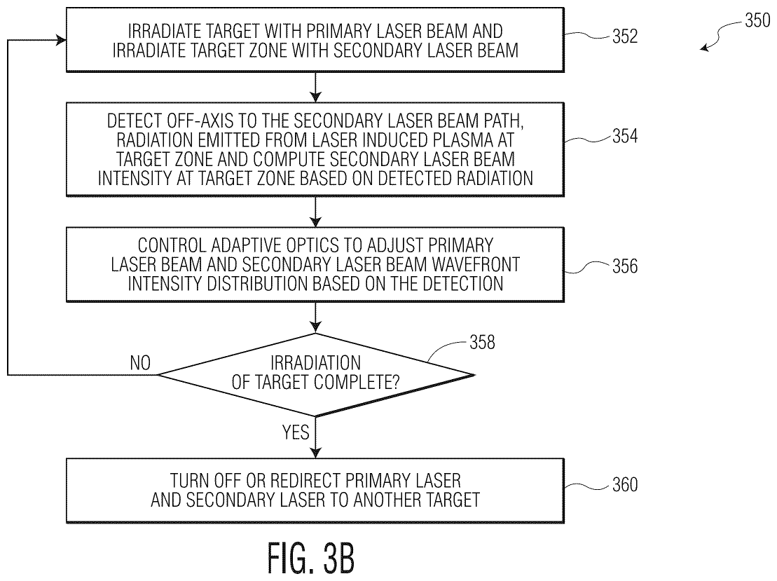

FIG. 3A shows a block diagram 300 of a target-free laser correction system with off-axis plasma detection. Off-axis plasma detection is a configuration where the system sensor is off-axis from the emitted laser beams and detects off-axis radiation generated by the laser-induced plasma. The target-free laser correction system with off-axis plasma detection in FIG. 3A generally includes primary laser 302A, secondary laser 302B, laser optics 304A, 304B, 304C, 304D and 304E, controller 301 including spatial phase controller 306A and data processor 306B, and off-axis radiation sensor 306C.

During operation controller 301 turns ON both primary laser 302A and secondary laser 302B which emit respective primary and secondary laser beams through optics 304A-304E. Optics 304A-304E may include mirrors (e.g., mirrors 304B and 304D), beam splitters (e.g., beam splitter 304A), corrective optics (e.g., adaptive optics 304C) and other lenses (e.g., lens 304E). The optics generally focus primary laser beam on a target (not shown) in the center of target zone 318, while the optics focus secondary laser beam on air in another region of target zone 318 (e.g., region short of the physical target). The secondary laser beam is a high-power laser beam (e.g., GW or TW peak power pulsed laser) that generates laser-induced plasma 312 in the target zone. The laser-induced plasma emits radiation 314 in various frequency spectrums as mentioned above. Radiation 314 is proportional to the intensity of the secondary laser beam at the target zone and therefore proportional to the focus of the laser beam (i.e., a properly focused laser beam generates laser-induced plasma that produces higher intensity radiation). In this example, radiation 314 is generally detected by off-axis sensor 306C (e.g., electromagnetic field strength meter, etc.) and then processed by data processor 306B to determine intensity of the secondary laser beam at the target zone. This determination is utilized by spatial phase controller 306A to control adaptive optics 304C with the goal of increasing (e.g., maximizing) the intensity of the secondary laser beam at the target zone. Generally, adaptive optics 304C is controlled to modify the output secondary laser beam wavefront to produce a modified intensity distribution 316A that compensates for distortions to the laser beam wavefront caused by atmospheric disturbances 308. The result is that the secondary laser beam wavefront is corrected as wavefront 310 which produces a corrected intensity distribution 316B of the secondary laser beam at the target zone. As mentioned above, since the primary laser beam is traveling along the same optical path and therefore also experiences atmospheric disturbances 308, the primary laser beam wavefront is also corrected for enhanced laser application to the physical target. Further operational details are described below.

FIG. 3B shows a flowchart 350 of the operation of the target-free laser correction system with off-axis plasma detection in FIG. 3A. In step 352, controller 301 controls primary laser 302A to irradiate the physical target (not shown) in the target zone 318 with a primary laser beam and controls the secondary laser 302B to irradiate a section of air in the target zone 318 with a secondary laser beam. The primary laser beam may be a laser beam (e.g., continuous wave laser or other laser) selected for a specific laser-based application (e.g., laser countermeasure, laser power beaming, etc.). The secondary laser beam may be a high-power laser beam (e.g., GW or TW peak power pulsed laser) that is powerful enough to generate laser-induced plasma in the air of target zone 318. The primary laser beam travels through beam splitter 304A and is reflected off adaptive optics 304C and mirror 304D before being collimated by lens 304E, emitted through atmospheric disturbances 308 and focused on a target (not shown) in the middle of target zone 318. The secondary laser beam is reflected from mirror 304B, travels through beam splitter 304A and is reflected off adaptive optics 304C and mirror 304D before also being collimated by lens 304E and emitted through atmospheric disturbances 308 and focused on a section of air on the edge of target zone 318.

The distance between the focal region of the primary laser beam and secondary laser beam can be selected based on various factors including but not limited to the atmospheric conditions, and the parameters of the lasers. For example, if the target is 1000 meters from the laser emitter, the primary laser beam may be focused at a distance of 1000 meters, while the secondary laser may be focused at a shorter distance of 900 meters. The result is that the primary laser beam is being focused on the physical target while the secondary laser beam is focused on air for generating the laser-induced plasma in a target-free manner.

It is noted that the secondary laser beam generates laser-induced plasma 312 which emits off-axis radiation 314. In step 354, sensor 306C detects the off-axis radiation 314 emitted from the laser-induced plasma, and since the radiation of the laser-induced plasma is related to intensity of the secondary laser beam, data processor 306B of controller 301 computes the intensity of the secondary laser beam at the target zone 318. In step 356, spatial phase controller 306A of controller 301 controls adaptive optics 304C to adjust the emitted secondary laser beam wavefront to achieve adjusted intensity distribution 316A that compensates for distortions in the wavefront as it travels through atmospheric disturbances 308. In other words, adaptive optics 304C outputs a pre-distorted laser wavefront that when distorted by atmospheric disturbances 308 results in a corrected wavefront 310 having corrected intensity distribution 316B. In step 358, controller 301 determines if irradiation of the target is complete or not (e.g., power beaming is complete or not). If irradiation is not complete, the primary and secondary lasers continue to emit the primary and secondary laser beams and wavefront adjustment step 356 is repeated either continuously or periodically to ensure corrected intensity distribution 316B. If irradiation is complete, then in step 360, controller 301 turns OFF or redirects primary laser 302A and secondary laser 302B to irradiate another target. As a result of the above-described operation, target-free operation of the secondary laser is used to correct the wavefront of the primary laser beam to ensure desired operation when irradiating the physical target.

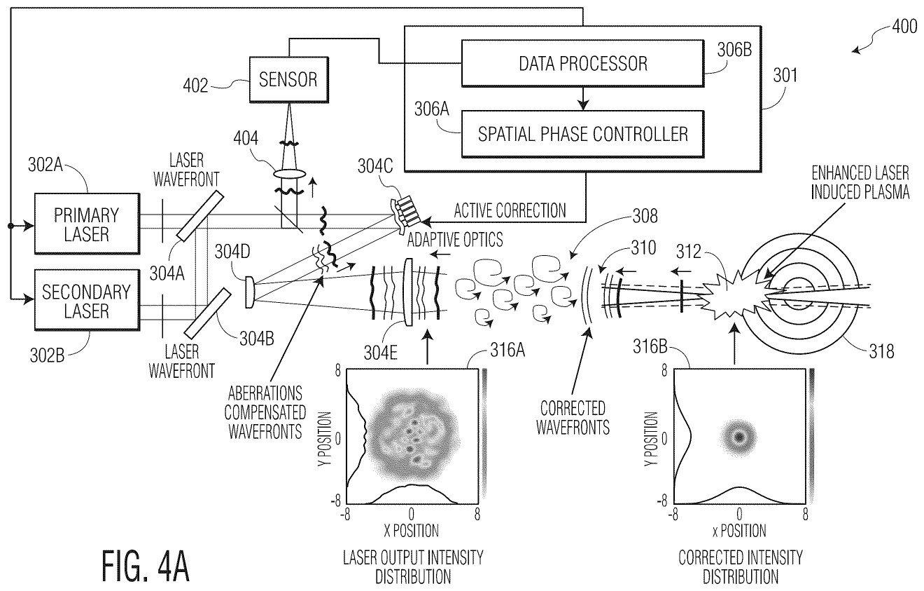

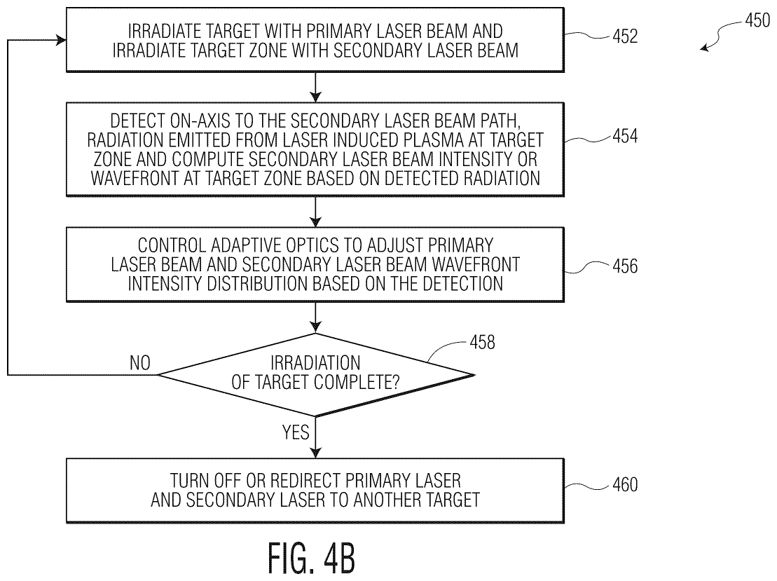

FIG. 4A shows a block diagram 400 of a target-free laser correction system with on-axis plasma detection. On-axis plasma detection is a configuration where the system sensor is on-axis with the emitted laser beams. In other words, the sensor detects back emitted (e.g., back scattered) optical signals along the laser beam path rather than detecting off-axis radiation as in FIG. 3A. These detections may be the intensity or the wavefronts of the back emitted signals.

The target-free laser correction system with on-axis plasma detection in FIG. 4A generally includes primary laser 302A, secondary laser 302B, laser optics 304A, 304B, 304C, 304D and 304E, controller 301 including spatial phase controller 306A and data processor 306B, and on-axis sensor 402 with accompanying sensor optics 404. During operation controller 301 turns ON both primary laser 302A and secondary laser 302B which emit respective primary and secondary laser beams through optics 304A-304E. Optics 304A-304E may include mirrors (e.g., mirrors 304B and 304D), beam splitters (e.g., beam splitter 304A), corrective optics (e.g., adaptive optics 304C) and other lenses (e.g., lens 304E). Again, the optics generally focus primary laser beam on a target (not shown) in the center of target zone 318, while the optics focus secondary laser beam on air in another region of target zone 318 (e.g., region short of the physical target). The secondary laser beam is a high-powered laser beam that generates laser-induced plasma 312 in the target zone.

The laser-induced plasma 312 emits back emitted optical signals that travel back along the optical path towards lens 304E. The back emitted optical signals are generally directed through the optics to sensor optics 404 and on-axis sensor 402 (e.g., intensity sensor or wavefront sensor) and then processed by data processor 306B to determine intensity or wavefront of the secondary laser beam at the target zone. Although not shown, sensor optics 404 may include spectral filters for isolating the back emitted optical signals due to the laser-induced plasma from the second laser beam, while rejecting back emitted optical signals from other sources such as the primary laser beam. The determined intensity or wavefront of the secondary laser beam is utilized by spatial phase controller 306A to control adaptive optics 304C with the goal of increasing the intensity of the secondary laser beam or achieving a desired laser beam wavefront at the target zone. Generally, adaptive optics 304C is controlled to modify the output secondary laser beam wavefront to produce a modified intensity distribution 316A that compensates for distortions to the laser beam wavefront caused by atmospheric disturbances 308. The result is that the secondary laser beam wavefront is corrected as wavefront 310 which produces a corrected intensity distribution 316B of the secondary laser beam at the target zone. Again, since the primary laser beam is traveling along the same optical path through the same atmospheric disturbances 308, the primary laser beam wavefront is also corrected for enhanced application to the physical target. Further operational details are described below.

FIG. 4B shows a flowchart 450 of the operation of the target-free laser correction system with on-axis plasma detection in FIG. 4A. In step 452, controller 301 controls primary laser 302A to irradiate the physical target (not shown) in the target zone 318 with a primary laser beam and controls the secondary laser 302B to irradiate a section of air in the target zone 318 with a secondary laser beam. The primary laser beam may be a laser beam (e.g., continuous wave laser or other laser) selected for a specific laser-based application (e.g., laser countermeasure, laser power beaming, etc.). The secondary laser beam may be a high-powered laser beam (e.g., GW or TW peak power pulsed laser) that is powerful enough to generate laser-induced plasma in the air of target zone 318. The primary laser beam travels through beam splitter 304A and is reflected off adaptive optics 304C and mirror 304D before being collimated by lens 304E and transmitted through atmosphere 308 and focused on a target (not shown) in the middle of target zone 318. The secondary laser beam is reflected from mirror 304B, travels through beam splitter 304A and is reflected off adaptive optics 304C and mirror 304D before being collimated by lens 304E, transmitted through atmospheric disturbances 308 and focused on a section of air on the edge of target zone 318. Again, the distance between the focal region of the primary laser beam and secondary laser beam can be selected based on various factors including but not limited to the atmospheric conditions, and the parameters of the lasers. It is noted that the secondary laser beam generates laser-induced plasma 312 which produces back emitted optical signals due to the on-axis radiation emitted by the laser-induced plasma. These back emitted optical signals travel back through the atmosphere along the same optical path and back through optics of the system, where, in step 454, they are captured by sensor optics 404 and detected by sensor 402. The back emitted optical signals produced by the laser-induced plasma are generally related to intensity and/or wavefront of the secondary laser beam. For example, the back emitted optical signal intensity increases as the laser intensity at the focal region increases. Likewise, the back emitted optical signal wavefront (e.g., plasma radiation which is originally spherical) scatters and becomes distorted as it travels from the focal region back to the sensor. Similar wavefront distortions are experienced by the laser wavefront given that the laser wavefront and the back emitted optical signal wavefront travel along the same optical path. Thus, data processor 306B of controller 301 either computes the intensity of the secondary laser beam at the target zone to adjust the laser or computes the wavefront distortion experienced by the back emitted plasma radiation along the optical path to adjust the laser. In step 456, spatial phase controller 306A of controller 301 controls adaptive optics 304C to adjust the emitted secondary laser beam wavefront so as to emit an adjusted intensity distribution 316A that compensates for distortions in the wavefront as the laser beam travels through atmospheric disturbances 308. In step 458, controller 301 determines if irradiation of the target is complete or not (e.g., power beaming is complete or not). If irradiation is not complete, the primary and secondary lasers continue to emit the primary and secondary laser beams and wavefront adjustment step 456 is repeated either continuously or periodically to ensure corrected intensity distribution 316B. If irradiation is complete, then in step 460, controller 301 turns OFF or redirects primary laser 302A and secondary laser 302B to irradiate another target. As a result of the above-described operation, target-free operations of the secondary laser are used to correct the wavefront of the primary laser beam to ensure desired operation when irradiating the physical target.

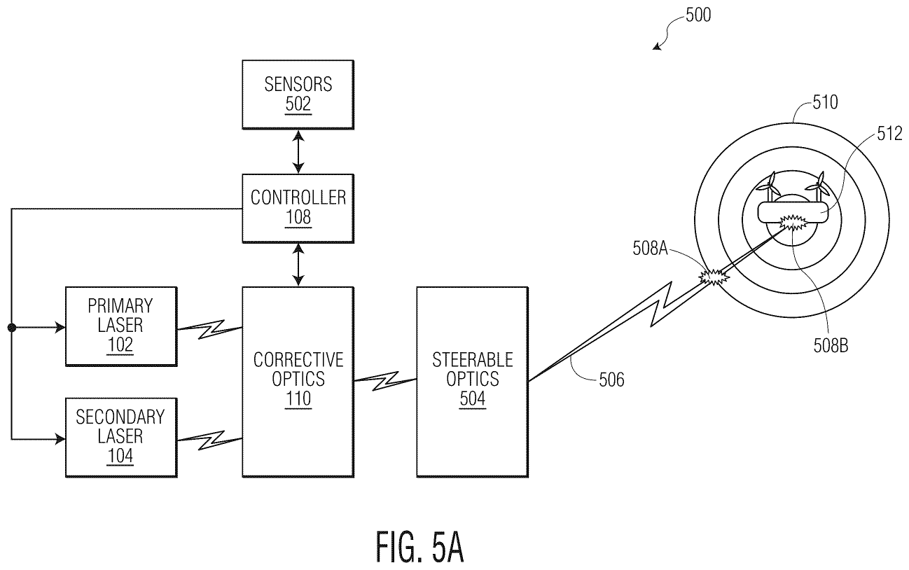

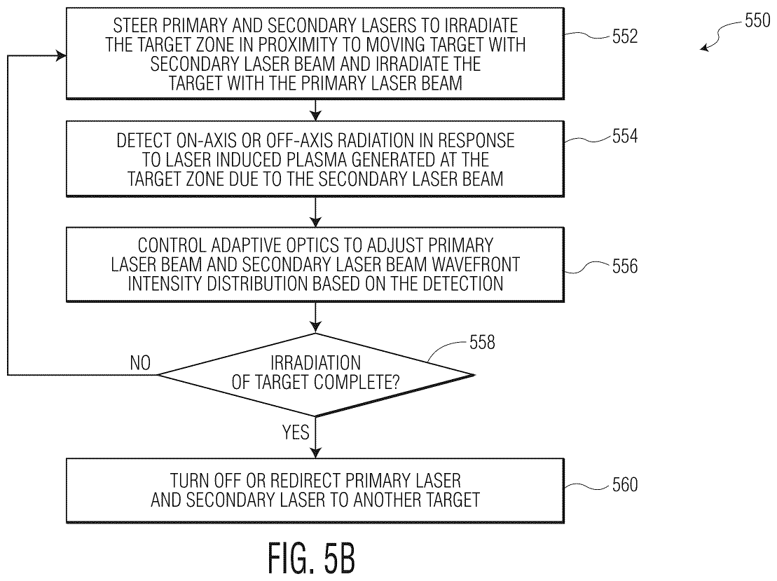

As mentioned above, laser target applications may include but are not limited to laser countermeasures (i.e., jamming laser guidance systems) and laser power beaming (i.e., remote wireless charging). The physical target in these applications may be static or may be moving (e.g., aircraft, etc.). When the target is moving, the lasers may be steered to track the object. FIG. 5A shows a block diagram 500 of a target-free laser correction system for a moving target application where the target is a flying drone 512. In this application example, drone 512 may be flying at a given altitude along a given trajectory. Drone 512 may include sensors (e.g., guidance sensor, wireless charging sensor, etc.) that may be targets for the primary laser beam. For example, the laser system may be used to irradiate drone 512 to perform laser counter measures (e.g., jam the drone guidance sensors) or perform laser power beaming (e.g., wirelessly charge the drone battery). In either case, the primary laser beam is to be focused on a targeted point 508B (e.g., guidance sensor, optical lens for wireless charging, etc.) of drone 512.

FIG. 5B shows a flowchart 550 of the operation of the target-free laser correction system for a target tracking application in FIG. 5A. In step 552, controller 108 controls primary laser emitter 102 and secondary laser emitter 104 to emit respective primary and secondary laser beams. Primary and secondary laser beams are emitted as beams 506 through optics such as corrective optics 110 and steerable optics 504. Controller 108 generally controls corrective optics 110 and steerable optics 504 to irradiate and focus the primary laser beam at point 508B on drone 512 and irradiate and focus the secondary laser beam at a point in air in target zone 510 to produce laser-induced plasma 508A. Controller 108 may control steerable optics 504 to track drone 512 based on feedback detected from sensors 502 which may include a radar emitter/receiver for tracking the position and movement of drone 512 to ensure that the primary laser beam is focused on drone 512. In step 554, sensors 502 which may also include on-axis optical sensors and/or off-axis radiation sensors detect radiation or the wavefront of back emitted optical signals emitted from laser-induced plasma 508A. In step 556, controller 108 controls an adaptive optics (not shown) of corrective optics 110 to adjust the emitted secondary laser beam wavefront so as to compensate for distortions in the wavefront as the laser beam travels through atmospheric disturbances towards drone 512. In other words, corrective optics 110 output a pre-distorted laser wavefront along 506 that when distorted by atmospheric disturbances results in a corrected wavefront having corrected intensity distribution. In step 558, controller 108 determines if irradiation of the target is complete or not (e.g., power beaming is complete or not). If irradiation is not complete, the primary and secondary lasers continue to emit the primary and secondary laser beams, steerable optics 504 continue to focus the laser beams on the target, and wavefront adjustment is repeated either continuously or periodically to ensure corrected intensity distribution. If irradiation is complete, then in step 560, controller 108 turns OFF or redirects primary laser emitter 102 and secondary laser emitter 104 to irradiate another target.

It is noted that the back emitted signals (e.g., microwave signals, optical signals) are produced by the plasma at the focal point in the target zone. In one example, this focal point may be a target free focal point (e.g., section of air) in a region of interest where the plasma is produced by interaction with the molecules in the air. In another example, this focal point may be target based focal point (e.g., physical object) where the plasma is produced by interaction with the molecules on the surface of the target. In either case, the intensity of the back emitted signals are used to control the adaptive optics with the goal of increasing (e.g., maximizing) intensity of the back emitted signals which indicates that the wavefront quality at the target is increasing (e.g., maximized).

Both on-axis and off-axis solutions are described herein. These solutions may be implemented separately or may be combined and implemented simultaneously. For example, a system may detect both on-axis back emitted signals and off-axis back emitted signals. Both of these signals may be processed by the controller to better estimate the quality of the laser wavefront at the target zone. For example, the processor may combine these signals in a fusion algorithm that provides varying weights to both on-axis and off-axis feedback with the goal of maximizing a fused metric. Furthermore, it is noted that both on-axis and off-axis solutions have benefits. Some benefits of the off-axis configuration include flexibility in the location of the detector, and a more simplistic optical system to collect the off-axis signal. Some benefits of the on-axis configuration include the ability to collect only the emission from the plasma (i.e., avoid confusion with other external signals), and the flexibility to utilize a wavefront sensor for collecting additional information of the back emitted signal including but not limited to tip and tilt which can be used to correct beam pointing instability.

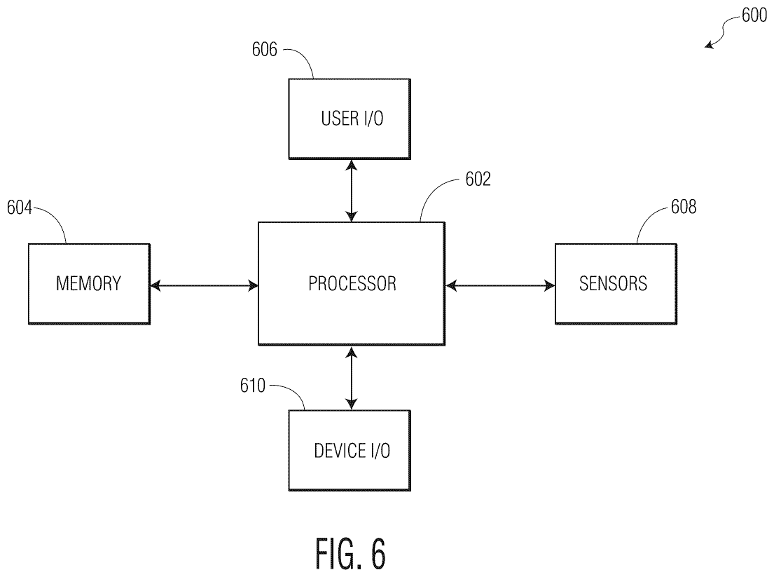

As mentioned above, the controller for the target-free laser correction system includes various functionality including but not limited to data processing of the received off-axis radiation or on-axis back fed optical signals, as well as spatial phase control of the adaptive optics and steerable mirrors. FIG. 6 shows a block diagram 600 of the controller hardware for the target-free laser correction system. In general, the controller may include a processor 602, memory 604, user input/output (I/O) 606 (e.g., keyboard, monitor, touchscreen, etc.), sensors 608 (e.g., wavefront sensor, radiation sensor, radar for tracking targets, etc.) and device I/O 610 (e.g., electrical connections to lasers, adaptive optics, steerable optics, etc.). In operation, processor 602 may receive instructions from software stored in memory 604 and/or user input from user I/O 606 to perform a desired laser application. In response to these instructions, processor 602 may transmit control signals to the primary laser, secondary laser, adaptive optics and steerable mirrors to emit the primary and secondary laser beams towards a target. Processor 602 may then analyze feedback from the radar system and laser-induced plasma detected by sensors 608. Processor may then instruct adaptive optics to adjust the laser beam wavefront and control the steerable optics to continue to track the target and properly focus the laser beams. In either case, processor 602 may coordinate the operation of the target-free laser system to achieve goals of the laser-based application.

It is noted that the primary laser beam and secondary laser beam may be controlled and emitted in various configurations. In a first example, the primary laser beam and secondary laser beam are emitted along the same optical path. In this first example, the primary laser beam may be focused on the physical target, while the secondary laser beam may be focused on a section of air short of the physical target. However, it is noted that the secondary laser beam does not have to be focused on air and may also be focused on the physical target as long as laser-induced plasma is generated. In other words, the focal region of the secondary laser beam is adjustable to any point from the exit aperture of the laser emitter optics to the target itself. In a second example, the primary laser beam and secondary laser beam are emitted along different optical paths. In this first example, the primary laser beam may be focused on the physical target along a first path, while the secondary laser beam may be focused on a section of air in front of the physical target (e.g., a point of space in which the target will travel in the future) along a second path at an angle relative to the first path. This may be useful for aircraft tracking where the secondary laser beam may be focused on a point in front of the nose of the aircraft, while the primary laser beam may be focused on the aircraft itself.

It is noted that the primary laser beam and secondary laser beam may be emitted simultaneously as described above. However, the primary laser beam and secondary laser beam may be emitted sequentially. For example, the secondary laser beam may be emitted for a period of time to generate laser-induced plasma, determine atmospheric disturbances and control the adaptive optics to compensate for these disturbances. The secondary laser may then be turned OFF and the primary laser beam may be emitted at the target to perform the laser applications described above. The controller may periodically repeat the above-described process such that the compensation performed by the adaptive optics is updated to reflect recent atmospheric conditions.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the disclosed example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A target-free laser correction system comprising:
a primary laser emitter configured to emit a primary laser beam on a target in a target zone;
a secondary laser emitter configured to emit a secondary laser beam on a region of air in the target zone;
optics optically coupled to the primary laser emitter and the secondary laser emitter, the optics configured to optically focus the secondary laser beam on the region of air in the target zone, correct a distortion of a wavefront of the secondary laser beam caused by atmospheric effects on the secondary laser beam, and focus the primary laser beam on the target in the target zone;
a sensor configured to detect energy emitted from laser induced plasma created by the secondary laser beam; and
a controller configured to control operation of the primary laser emitter, the secondary laser emitter, the optics and the sensor.

2. The system of claim 1, wherein the sensor is configured to detect the energy emitted from the laser induced plasma external to a path of the secondary laser beam.

3. The system of claim 1, wherein the sensor is configured to detect the energy emitted from the laser induced plasma along a path of the secondary laser beam.

4. The system of claim 1, wherein the optics include an adaptive optics for correcting the distortion of the wavefront.

5. The system of claim 1, wherein the controller is further configured to correct the distortion of the wavefront in the target zone by controlling the optics to pre-distort the wavefront of the emitted secondary laser beam such that pre-distorted wavefront counteracts the distortion caused by the atmospheric effects.

6. The system of claim 1, wherein the controller is further configured to correct the distortion of the wavefront such that the corrected wavefront in the target zone has a power intensity distribution set by the controller.

7. The system of claim 1, wherein the controller is further configured to determine the region of air in the target zone as being a set distance from the target in the target zone.

8. The system of claim 1, wherein the controller is further configured to:
a) control the secondary laser emitter to emit the secondary laser beam through the optics to focus the secondary laser beam on the region of air in the target zone,
b) control the sensor to detect the energy emitted from the laser induced plasma created by the secondary laser beam irradiating the region of air in the target zone,
c) estimate, based on the detected energy emitted from the laser induced plasma, a quality of the wavefront of the secondary laser beam in the target zone,
d) control the optics to correct the distortion of the wavefront, and
e) control the primary laser emitter to emit the primary laser beam through the optics to focus the primary laser beam on the target in the target zone.

9. The system of claim 1, wherein the controller is further configured to analyze the energy emitted from the laser induced plasma after the correction to confirm that the distortion of the wavefront is corrected.

10. The system of claim 1, wherein the controller is further configured to control the optics to adjust the focus of the secondary laser beam and the primary laser beam between the region of air in the target zone and the target in the target zone respectively.

11. A target-free laser correction method comprising:
a) controlling, by a controller a secondary laser emitter to emit a secondary laser beam through optics to focus the secondary laser beam on a region of air in a target zone;
b) controlling, by the controller, a sensor to detect energy emitted from laser induced plasma created by the secondary laser beam irradiating the region of air in the target zone;
c) estimating, by the controller, based on the detected energy emitted from laser induced plasma, a quality of a wavefront of the secondary laser beam in the target zone, a distortion caused by atmospheric effects on the secondary laser beam;
d) controlling, by the controller, the optics to correct the distortion of the wavefront; and
e) controlling, by the controller, a primary laser emitter to emit the primary laser beam through the optics to focus the primary laser beam on a target in the target zone.

12. The method of claim 11, further comprising:
detecting, by the sensor, the energy emitted from the laser induced plasma external to a path of the secondary laser beam.

13. The method of claim 11, further comprising:
detecting, by the sensor, the energy emitted from the laser induced plasma along a path of the secondary laser beam.

14. The method of claim 11, further comprising:
correcting, by an adaptive optics of the optics, the distortion of the wavefront.

15. The method of claim 11, further comprising:
correcting, by the controller, the distortion of the wavefront in the target zone by controlling the optics to pre-distort the wavefront of the emitted secondary laser beam such that pre-distorted wavefront counteracts the distortion caused by the atmospheric effects.

16. The method of claim 11, further comprising:
correcting, by the controller, the distortion of the wavefront such that the corrected wavefront in the target zone has a power intensity distribution set by the controller.

17. The method of claim 11, further comprising:
determining, by the controller, the region of air in the target zone as being a set distance from the target in the target zone.

18. The method of claim 11, further comprising:
periodically repeating, by the controller, steps (a)-(e) to compensate for the atmospheric effects that vary over time.

19. The method of claim 11, further comprising:
analyzing, by the controller, the energy emitted from the laser induced plasma after the correction to confirm that the distortion of the wavefront is corrected.

20. The method of claim 11, further comprising:
controlling, by the controller, the optics to adjust the focus of the secondary laser beam and the primary laser beam between the region of air in the target zone and the target in the target zone respectively.
